(19) United States
(12) Patent Application Publication
(10) Pub. No.: US 2008/0313260 A1
(43) Pub. Date: Dec. 18, 2008

(54) Automated website generation

(75) Inventors: Stephen Sweet, Petaluma, CA (US); Blaine Transue, Sonoma, CA (US)

Correspondence Address: Stephen Sweet;WildFireWeb Inc., 246 Petaluma Blvd. North, Petaluma, CA, 94952, US

(73) Assignee: WildFireWeb Inc., Petaluma, CA (US)

(21) Appl. No.: 12/139,471

(22) Filed: Jun. 14, 2008

Related U.S. Application Data
(60) Provisional application No. 60/944,400, filed on Jun. 15, 2007.

(51) Int. Cl. G06F 15/16

(52) U.S. Cl. 709/201

(57) ABSTRACT

A system that automates the creation of websites for organizations that share similar organizational structure and for which publicly accessible information is available. The system automatically populates web pages with content derived from information gathered from public sources in addition to content that is developed for each type of organization. The system also acts as a dynamic web site hosting system to deliver the web sites to the public via the Internet. The system also acts as a web site maintenance system which allows authorized users the ability to add and delete web pages, edit the content of web pages, add sections to the web site, and add other features to web pages such as calendars, blogs, forms and image galleries, all using an ordinary web browser such as Internet Explorer or Mozilla Firefox without the need to install additional software on a client computer. All information including web page content, user identification information, and organization information, is stored in databases and files such that a single server computer can host multiple school web sites with a single instance of software installed on the server. A web-based application named “slates” is presented as an alternative way of adding and managing editorial content on web pages.

### CROSS-REFERENCE TO RELATED APPLICATIONS

U.S. Provisional Patent Application No.: 60/944,400
Filed: Jun. 6, 2007
Title: Automated Website Generation

### FIELD OF THE INVENTION

The present invention relates to an authoring system and method for generation and maintenance of user websites containing user updateable variable content web pages. More particularly the present invention relates to automated creation of websites for organizations that are pre-populated with specific information about the organization that is gathered from public data sources as well as generic content that is applicable to similar organizations.

### BACKGROUND OF THE INVENTION

The creation of websites is a laborious process, requiring significant effort on the part of skilled web designers and other information technology experts, and thus proving both time-consuming and expensive. Much of this expense is due to the fundamentally different structure and goals of the various organizations for which the websites are created.

Certain organizations, however, share similar structure and goals, and thus would all be capable of using the same essential layout for their websites. Additionally, due to factors such as governmental regulations, certain types of organizations, such as educational institutions, make their pertinent information publicly available. Thus, not only can such organizations leverage a common website structure, but much of the data to be included within the specific pages of that structure is already readily available. It would be highly advantageous to be able to automate the construction of websites for such organizations.

In addition to the initial cost of designing and constructing a website are the ongoing costs of content revisions that are necessary on a regular basis. Schools for example have constantly changing information including class schedules, calendars, policies and fundraising events. School staff changes often, teachers offer new class assignments regularly and the school community needs a way to be informed. The content on websites for schools is typically out of date due to the high cost and high turnaround time to make changes to the content of web pages.

It was with this understanding of the current problems that schools and similar organizations face that the idea for the present invention was formed and the preferred embodiment of the invention as described herein was created.

### SUMMARY OF THE INVENTION

The present invention is a system that automates the construction of websites for organizations, and in the present preferred embodiments, for public and private K-12 schools. In addition to building an organization's websites automatically through the use of data gathered from a variety of public sources to populate the pages of website, the system also acts as a dynamic website hosting system to deliver the websites to the public via the Internet, and as a website maintenance system which allows authorized users the ability to edit the content of web pages in the website using an ordinary web browser without the need to install additional software on a client computer.

The system takes advantage of the fact that information exists and is in the public domain for most public and private K-12 schools in the U.S. This information consists of items such as school name, address, phone, fax, principal's name, contact information, enrollment, number of teachers and staff, standardized testing results and reports, map latitude and longitude, district name, district address, etc.

School systems are organized in a hierarchy, starting with federal, then state, county or region, district, and finally an individual school. K-12 schools throughout each region and across a country operate with similar rules and policies, and use many standardized documents that are available in the public domain.

By combining school data and standardized documents with server software that can build and deliver websites to the Internet, the invention automates the creation of school websites.

With a content management system, the system allows authorized user to add and modify content of their websites directly using no special software other than a standard web browser. New sections and pages of the website can be added and modified for teachers, classes and departments in a simple and intuitive manner.

By storing different language versions of web page content in the database and by allowing a website visitor to select the language of choice, the same website can be displayed in more than one language. This becomes particularly important in schools and communities that are multi-lingual.

Special features and applications are installed automatically on various web pages within each school website. Some of these special features can also be installed manually on any web page by an authorized user. These features include event calendars, an emergency alert system, syndicated news feeds, blogs, photo galleries, shopping carts, and “slates”—a new invention presented here.

Embodiments of the invention provide automated construction of websites. The example embodiments focus specifically on educational organizations, and more specifically on schools having grades K-12. It is appreciated, however, that that the invention is not limited to an educational context, but rather applies to any type of organization with a structure similar to others of its kind, and for which the data to be incorporated into its website is publicly available.

In one embodiment, the system consists of a database incorporating publicly-available data for a number of organizations, website page data templates specifying the default structure and data locations of the individual pages of the website, a computing device producing an organization-specific website by incorporating into the website page data template information from the database pertaining to that particular organization, and a user interface allowing a representative of the organization (authorized user) to select the particular website page data templates used and/or to manually customize the pages of the resulting website.

In such an embodiment, the operations of the system broadly consist of an initial website layout specification phase, automated page construction, and optional page editing.

The initial website layout construction process begins with an employee or other authorized representative of the organization choosing to activate the website, the procedures involved including, for example, providing proper authentication information. Subsequently, the employee specifies various parameters corresponding to the features desired on the completed website, such as a desired color scheme or style template, and these settings are subsequently used as the defaults for the layout and aesthetics of the pages on the website. Additionally, the employee may optionally review and correct organization data that is stored within the system database. The result is a set of web page data templates, the data templates incorporating the specified desired features and having placeholders specifying the locations of organization-specific data. The data templates are later accessed during automated page construction.

The automated page construction generates a web page for display in a user's web browser, combining the web page data templates with the organization-specific data stored in the database. In one embodiment, page construction is performed dynamically each time that a user requests one of the organization's web pages. In other embodiments, web pages generated from the data templates may be stored persistently on a server after they are first generated.

During the optional page editing, an employee or other authorized user of the organization views and edits web page content within a standard web browser, the modified content being persistently stored after the editing process is complete and used when later generating the corresponding web page during automated page construction.

Additionally, in one embodiment web pages comprise content that is related to the organization's location-oriented information stored in the database. For example, advertisements are selected so as to best suit the demographics of the area; maps are generated based on the stored address or other location data; and emergency preparedness procedures are tailored to the region where the organization is located.

In one embodiment, a new invention named “slates” is presented as an alternative way of adding and managing editorial content on web pages. “Slates” are flexible components of a Web-based user interface that allow organization of, and interaction with, data. Each slate may have a different author and/or editor and thus allows access control of particular regions within a page. Further, slates provide more flexible and targeted communication about an item of information via mechanisms such as corresponding contact forms and subscription lists. Slates further allow better graphical presentation of information than conventional user interface elements, including drag-able slate reordering and minimization of individual slates not in use to better preserve screen space.

A system for authenticating a person authorized to create and manage a school website is presented.

A system to deliver advertising that is targeted by locale and user demographics is presented.

### BRIEF DESCRIPTION OF THE DRAWINGS

FIG. 1A and FIG. 1B are examples of web browser screens showing the activation of a new school website using a secret activation code supplied to a school administrator.

FIG. 2A through FIG. 2F show the steps involved in creating a new school website once activated.

FIG. 3 is a sequence diagram illustrating website user authentication and website activation for a new school website.

FIG. 4 is a block diagram showing the relationships between a server machine and a client machine including databases, media storage and dynamic content generation.

FIG. 5 is a sequence diagram illustrating dynamic web page generation.

FIG. 6 is an example of a web browser screen showing a completed school website.

FIG. 7 is a block diagram illustrating content being edited by an authorized user in a web browser and the edited content being stored on a server computer.

FIG. 8 is a sequence diagram illustrating the process of an authorized user editing a web page.

FIG. 9 shows a web page after an authorized user has logged in to begin editing.

FIG. 10 shows a web page as an authorized user edits a content area of the page.

FIG. 11A thru FIG. 11E show the steps in adding a new web page, editing the page title, and arranging the order of the page in the website navigation.

FIG. 12A and FIG. 12B illustrate the replacement of special tags in the content of a web page with content retrieved from a database.

FIG. 13A and FIG. 13B are examples of a school website home page and a school website sub-page illustrating top-level and sub-level hierarchical navigation.

FIG. 14 is a web page showing a list of upcoming events being automatically poplulated from a school calendar located on a different web page.

FIG. 15 is a web page showing an automatically generated location map based on the school's physical address or latitude/longitude coordinates.

FIG. 16 is a web page showing an example of pre-populated content and links originating from the California Department of Education.

FIG. 17 is a web page showing standardized testing reports for a school automatically fetched from a state agency.

FIG. 18A thru FIG. 18C illustrates a method of embedding special tags in the content of a web page to retrieve and populate content from a broadcast website.

FIG. 19 shows the signup form for an emergency alert system.

FIG. 20A thru FIG. 20E show the steps involved in creating a teacher section on a school website and adding several pages (slates) to the teacher section.

FIG. 21A thru FIG. 21F show how teacher sections have automatic teacher contact forms and subscription.

FIG. 22A and FIG. 22B show the placement of an event calendar into a web page and the addition of an event.

FIG. 23 shows a donation shopping cart added to a web page.

FIG. 24 shows a group of buttons to select various special features to be installed in a web page.

FIG. 25A thru FIG. 25E show the steps involved in adding a photo gallery to a web page.

FIG. 26A thru FIG. 26GF show the steps involved in adding a blog to a web page and managing and editing the content of a blog.

FIG. 27A thru FIG. 27H show the steps involved in adding slates (multiple sub-pages) to a web page, managing authorized users for slates, and managing and editing the content of slate tablets.

FIG. 28A and FIG. 28B show the steps involved in adding syndicated news feeds (RSS) to a web page.

FIG. 30 shows a dynamically generated advertisement on a web page.

### DETAILED DESCRIPTION OF THE PREFERRED EMBODIMENTS

In the pages that follow, a detailed description is provided of WebSchoolPro®, an example embodiment of the invention specifically oriented towards websites for schools including grades K-12. The description is organized as follows: First, Part I presents an overview of the embodiment. Next, Part II describes the different phases involved in the overall process of providing a website customized to an individual school, including the initial collection and storage of school information, the initial activation by an authorized user of a school website, and the subsequent dynamic generation and editing of the pages of the website. Finally, Part III presents further technical details, including the details of content substitution and the various tags used therein, the navigational hierarchy for web pages in the example website, descriptions of the various web pages and features provided by the exemplary website, and the structure of database tables for storing school-specific, user-specific and website-specific information and content.

### Part I

WebSchoolPro® is a system that automates the construction of Internet websites for public and private K-12 schools in the U.S. and elsewhere in the world. In addition to building school websites automatically through the use of data gathered from a variety of public sources to populate the pages of a school website, the WebSchoolPro system also acts as a dynamic website hosting system to deliver the websites to the public via the Internet, and as a website maintenance system which allows the website owners the ability to edit the content of web pages and add features to web pages in the website using an ordinary web browser such as Internet Explorer or Mozilla Firefox without the need to install additional software on a client computer.

WebSchoolPro takes advantage of the fact that State and Federal databases exist and are in the public domain for most public and private K-12 schools in the U.S. These databases contain information such as school name, address, phone, fax, principal's name, contact information, enrollment, number of teachers and staff, standardized testing results and reports, map latitude and longitude, district name, district address and others. Refer to TABLE 1 for a list of typical information collected and stored for schools.

School systems in the U.S. are organized in a hierarchy, starting with federal, then state, county, district, and finally an individual school. K-12 schools throughout each region and across the nation, operate with similar rules and policies, and use many standardized documents that are available in the public domain.

By combining school data and standardized documents with server software that can build and deliver websites to the Internet, WebSchoolPro automates the creation of school websites for school in the database.

With a content management system, WebSchoolPro allows authorized users to add and modify content of their websites in real-time using no special software other than a standard web browser. New sections and pages of the website can be added and modified for teachers, classes and departments in a simple and intuitive manner.

By storing different language versions of web page content in the database and by allowing a website visitor to select the language of choice, the same website can be displayed in more than one language. This becomes particularly important in schools and communities that are multi-lingual.

Special features and applications are installed automatically on various web pages within each school website. Some of these features can also be installed manually by an authorized user on any web page. These features include event calendars, emergency alert systems, syndicated news feeds (RSS), blogs, photo galleries, shopping carts and “slates”—a new invention presented here.

A new invention named “slates” is presented as an alternative way of adding and managing editorial content on web pages.

A system for authenticating a person authorized to create and manage a school website is presented.

A system to deliver advertising that is targeted by locale and user demographics is presented.

### Part II

### School Data Retrieval and Consolidation

Data for schools is collected from various state and federal agencies and consolidated into a database for use by the WebSchoolPro system. Since source data is in a variety of forms, including spreadsheet files, databases files, CSV (comma separated text) files, PDF, Text, and other formats, various methods for retrieval and formatting are used for each area such as state, county, school district or school, on a case-by-case basis. In some cases automated programs have been developed to extract information. In other cases manual data entry is required. Typical examples of data can be found at California Department of Education (CDE) on the Data & Statistics website at http://www.cde.ca.gov/ds/ and the Texas Education Agency (TEA) on the Data Resources & Research website at http://www.tea.state.tx.us/data.html. In addition to the data that is available on the Internet, some states offer more complete data for purchase and available in electronic documents.

### Web Site Activation Code Generation and Distribution

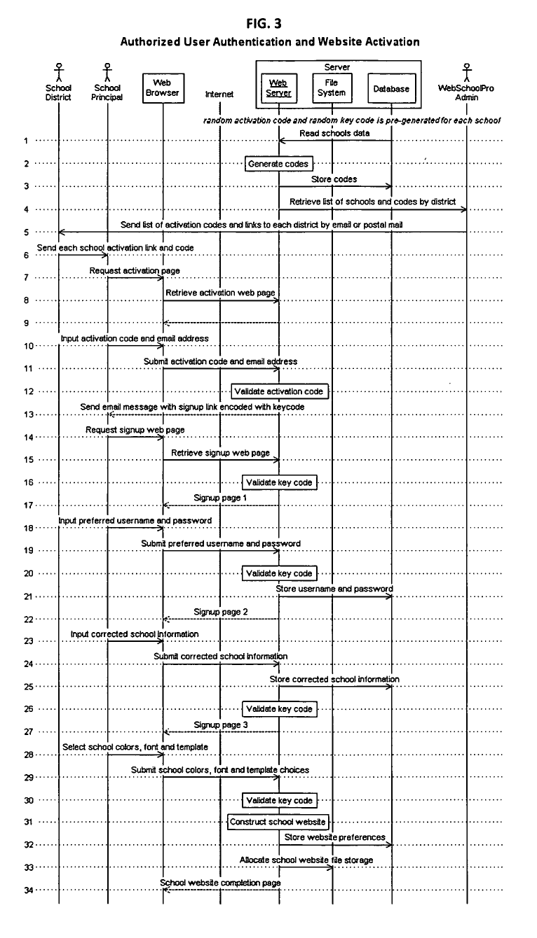

Refer to FIG. 3, a sequence diagram showing the process of authorized user authentication and website activation, Table 1—school database, and to Table 3—activation and authentication database.

A unique identifying number identifies each school in a database. Each school's identifying number (school_code) is read from the database (1) and a random activation code and a random key code are generated programmatically (2). These codes are stored in a database (activation_code, key_code) (3).

An activation link is generated for each school in the database, each link pointing to a program on the server computer and containing the school identifier for the given school. One unique activation code and one unique random key are associated with each activation link.
Example activation link and associated activation code and random key:
http://webschoolpro.com/signup/activate.php?school_code=01100170109835
activation code: e39f-0a35-144c-4873-a436
random key: p5u7OuOAasqPVQr3TVW8bv3BzAdR6
(please note that these examples are not valid for security purposes)

Activation links and associated activation codes are sent by post and/or email to associated school district superintendents or school principals (4 and 5). School district superintendents may re-distribute each activation link and activation code for a single school to the appropriate authorized user such as a school principal or a school IT professional (Step 6).

In the event that a school wishes to sign up for a website without receiving an activation code from their school district office, the school can request an activation code by phone or email, and with proper credentials the school will be issued the activation link and activation code.

### Website Activation Process

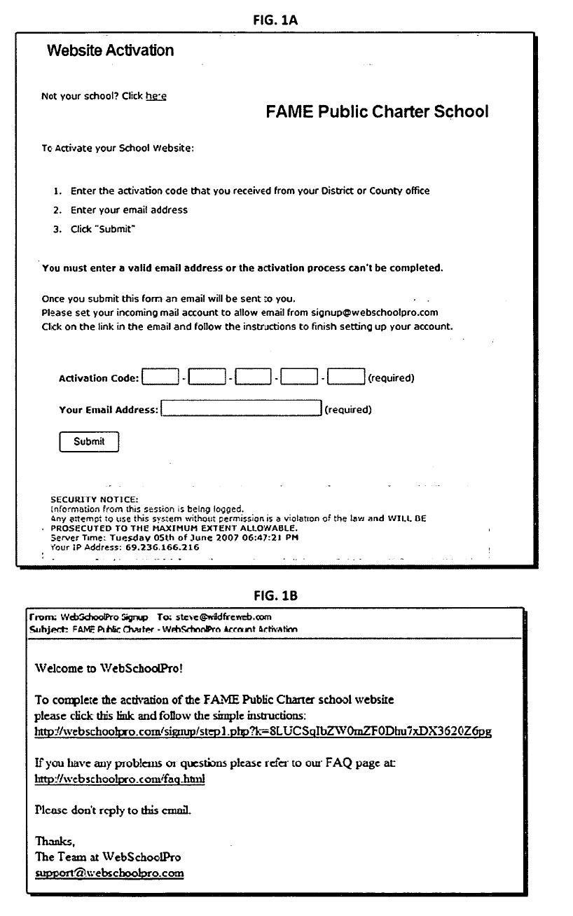

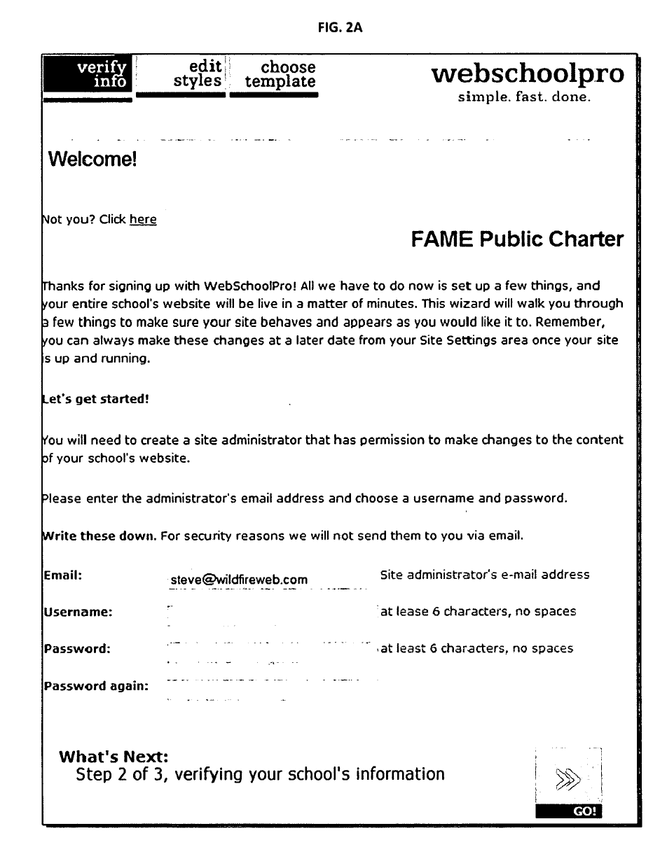

Using a client web browser, the authorized user visits the activation link and enters the activation code and email address (7 thru 11) into a web form (FIG. 1A). Upon clicking “Submit” the server validates the supplied information (12). If invalid information is entered the user presented with and error message and the same form again.

The web server sends an email (FIG. 1B) to the email address entered previously, the email containing a link to the next step of activation. The link contains the random key-code generated previously. This email insures that the person signing up has a valid email address. Email address, time-stamp and IP address of the activation activity is recorded in a database, which can be used to detect fraud.

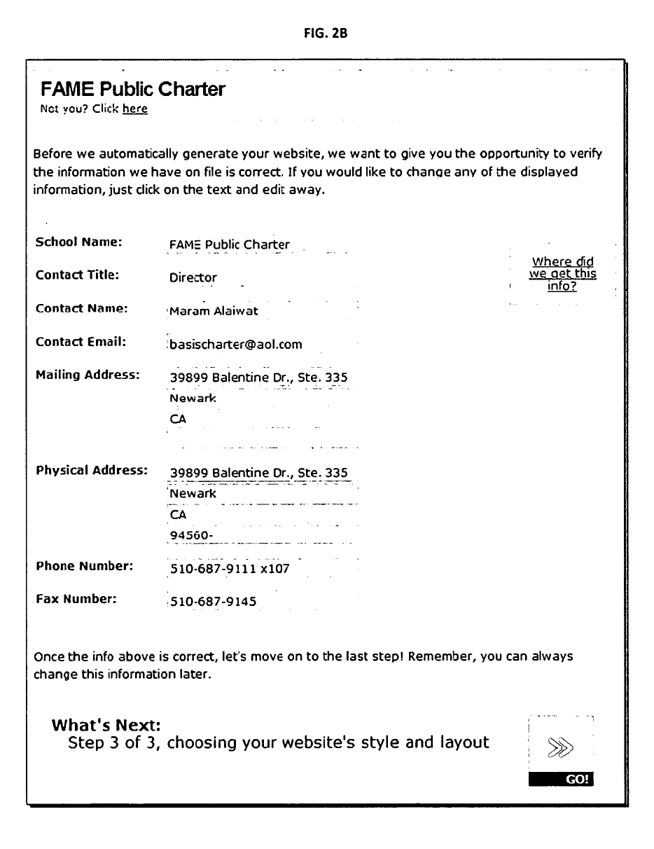

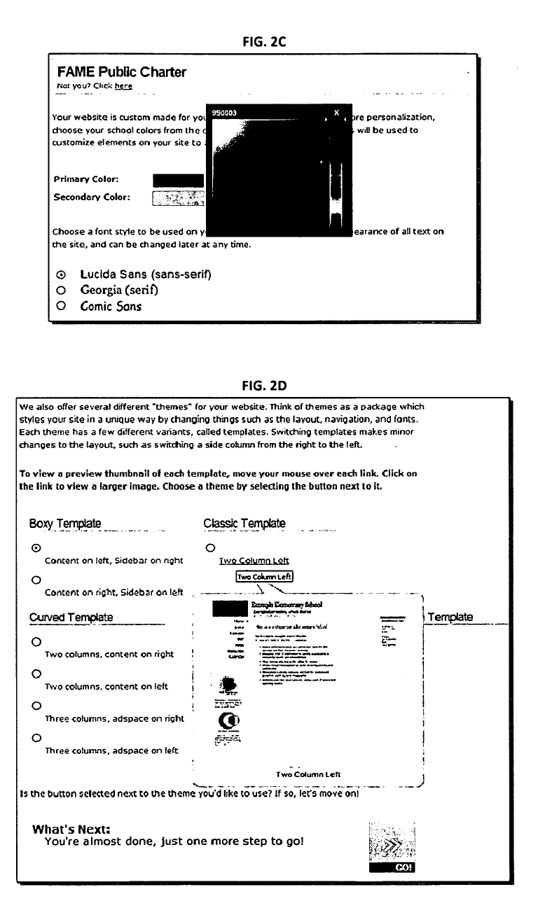

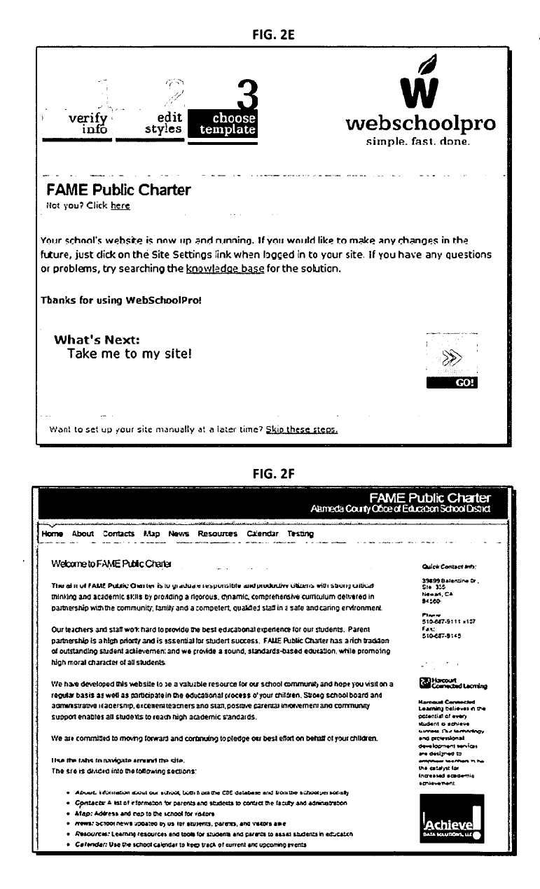

The authorized user receives the activation email. The authorized user clicks the link provided in the email (14 and 15) and is directed via a web browser to the server where the key code is validated (16). If a valid key code is present, signup page 1 (FIG. 2A) requesting an administrator's username and password (14) is presented to the user. The user enters their choice for username and password (18) then clicks “Go” which submits the information to the server computer (19) where the key code is again validated (20). If the information and key code are determined to be valid then the information is stored in the authorized user database and associated with the school being activated, and the user is directed to signup page 2 (FIG. 2B).

The authorized user is presented with signup page 2 (22) a pre-populated form (FIG. 2B) where they can verify and correct certain information about the school that was previously collected from public sources and stored in the database. The authorized user makes changes if necessary and clicks “Go” (24) which submits the information to the server computer where the key code is validated and the information is stored in the schools database (25). The user is directed to signup page 3 (FIG. 2C).

The authorized user is presented with signup page 3 (27) where they can select the primary and secondary colors (school colors) for the website, the default font (FIG. 2C), and the preferred design template for the website (FIG. 2D) (28). The user clicks “Go” (29) which submits the selections to the server computer where the key code is validated and the selections are stored in the schools database.

Once the school information and preferences have been collected from or verified by the authorized user and stored in the database, file storage is allocated on the server for the school, and the school website is constructed (31) by adding records to the website database (Table 4) and web page database (Table 5) and populating the content areas of the website database and web page database with content specific to the school and general to all schools. In a second implementation, web pages files are stored in the server's file system for access by standard web server system.

The user is directed to signup page 4 (FIG. 2E) for a welcome message, or directly to their new website (34).

The authorized user is finished building their school website (FIG. 2E). Once they click “Go” they are taken to their new website (FIG. 2F) where they can login with their chosen username and password and begin adding and editing web page content and features, and adding teachers and departments and other web pages.

### Dynamic Web Page Generation for Websites

The web server and associated server programs and server database generate and output web pages (HTML documents) dynamically when a client web browser requests web pages. By combining web page content, school specific information and web page template(s) which define web page layout, design and editable content areas, the server constructs web pages on demand. Web pages are delivered directly from the web server to the client web browser via the Internet without intermediate storage of the web pages on the server. Methods are also implemented to cache certain web pages to the server file system so that pages need not be regenerated unless content has been modified.

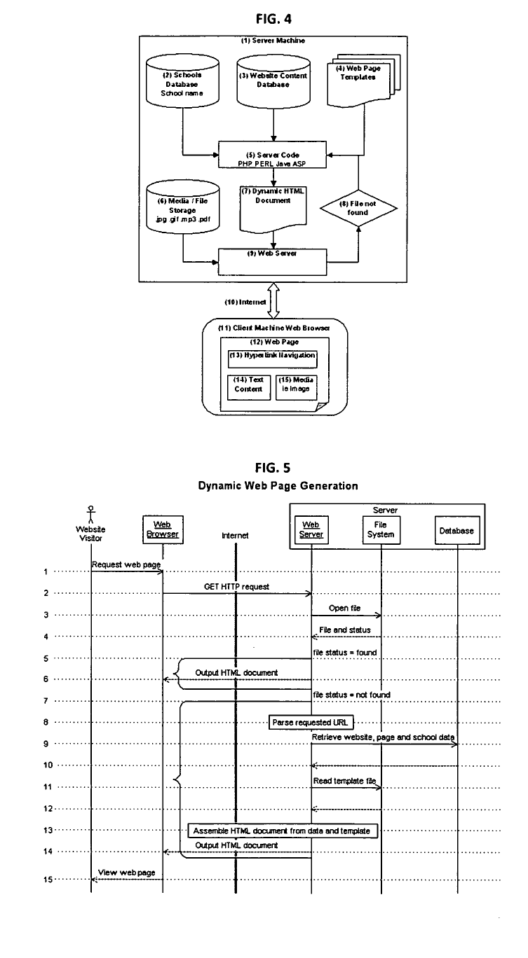

Refer to block diagram in FIG. 4 and sequence diagram in FIG. 5

1. Client Web Brower (11) requests a web page from the internet via an HTTP GET command such as “GET http://webschoolpro.com/CA01611196000004/index.html”

2. Web server (9) receives the request and searches server file system (6) for specified file. File system (6) returns a “File Not Found” status (8) because no physical file resides in file system. A “File Not Found” status is interpreted as a need for dynamic generation of a web page and is redirected via Apache mod-rewrite module to a PHP (or other language) server program/script (5).

3. Server program (5) reads the requested URL and parses the URL into several parts. The URL http://webschoolpro.com/CA01611196000004/index.html is broken into 3 parts:

Part 1—webschoolpro.com—identifies the domain being requested

Part 2—CA01611196000004—identifies a school by State and school code

Part 3—page1.html—identifies one page of the school website

4. In another variation, a URL may be constructed as http://myschool.com/page1.html where the URL is broken into 2 parts:

Part 1—myschool.com identifies a specific school website

Part 2—page1.html identifies one page of the school website

5. Server program (5) inspects the domain name i.e. myschool.com and compares it to a database table of school website domains. If school is found in database then program continues with step 7. If school is not found in database then program continues with step 6.

6. Server program (5) inspects the Website content database (3) and the Schools Database (2) for the presence of an index to the State “CA” and school code 01611196000004 and if not present in the database issues a “File Not Found” error via Web Server (9) to Client Web Browser (11).

7. Server program (5) has detected the presence of the requested school in the database. Website specific information is read into memory from Website Content Database (3), page specific information for “page1.html” is read into memory from the Website Content Database (3), information for other pages in the school website are read from the Website Content Database (3) and school specific information is read into memory from School Database (2).

8. Website and page specific information includes filename or database record for Web Page Template (4). Web Page Template (4) is retrieved from local file system or database into memory, and server program (5) inserts appropriate content previously retrieved from database into certain marked up areas/sections of the template to create an HTML compatible document which is stored in memory.

9. Information for other pages in the website is constructed into hyperlink navigation (13) from data retrieved from the database, and placed into the Web Page Template (4) in previously marked up sections. This creates a method for the Client Web Browser to navigate between various web pages of the school website.

10. Completed HTML document (Web Page) (12) is written by Server program (5) to Web Server (6) that delivers final HTML document to Client Web Browser (11) (FIG. 6).

11. HTML document (Web Page) (12) may contain markup language to insert certain images and other media (15) into the web page (12). These images or media may reside on the server file system of Server Machine (6). Additional GET requests for these documents are made by the Client Web Browser (11) to the Web Server (9). Since these files physically exist in the File System of the Server (6), they are immediately returned via the Web Server (9) to the Client Web Browser (11).

### Editing Content of a Web Page

When an authorized user logs into the server with a secret username and password and enters editing mode, the server supplies additional code and markup in each web page that allows the user to edit the contents of the web page using a standard web browser with no additional software installed on the client computer.

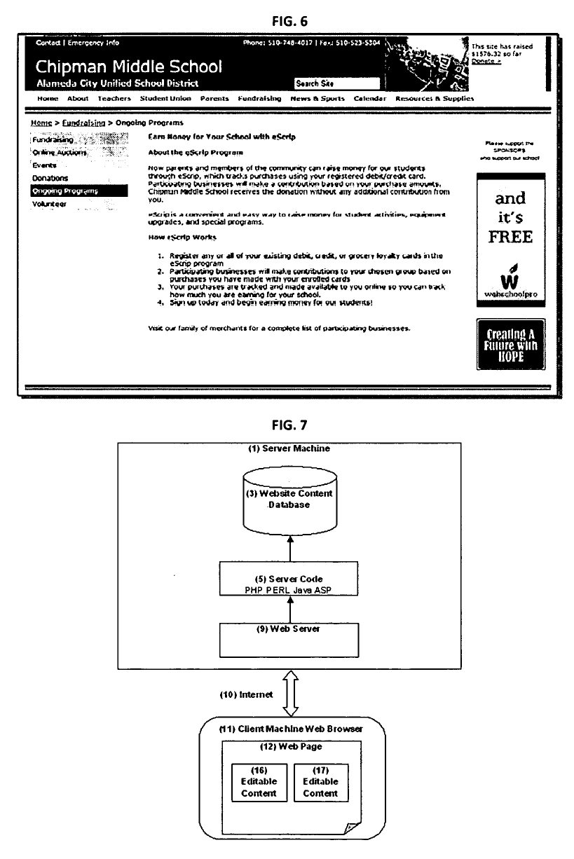

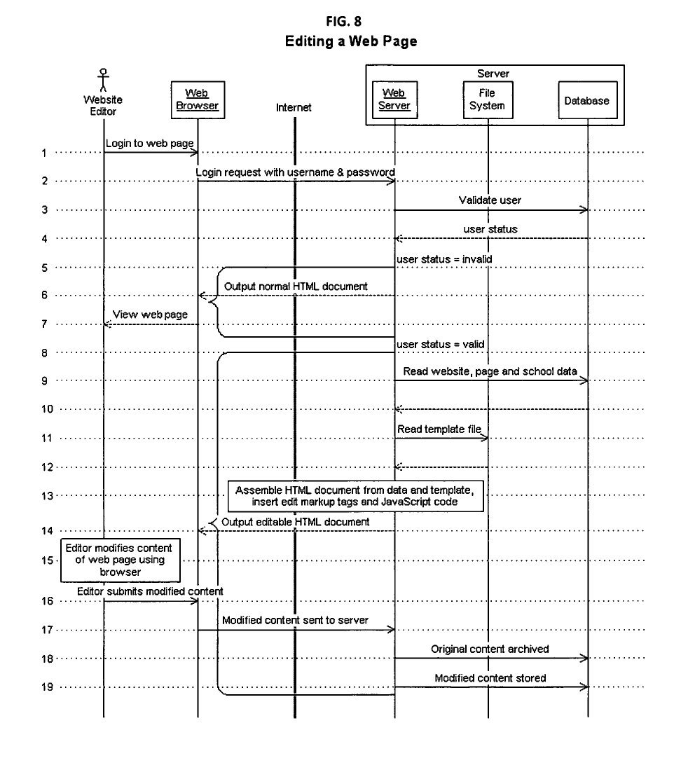

Referring to block diagram FIG. 7 and sequence diagram FIG. 8, the editing of the content of a web page using a standard web browser takes place as follows:

1. Web page is requested and dynamically constructed as described in the preceding section “Dynamic Web Page Generation”. If client user has logged into the server and entered into editing mode, additional content and code is inserted in the web page consisting of editable areas defined by certain HTML tags and identifiers, and browser executable code in the form of JavaScript.

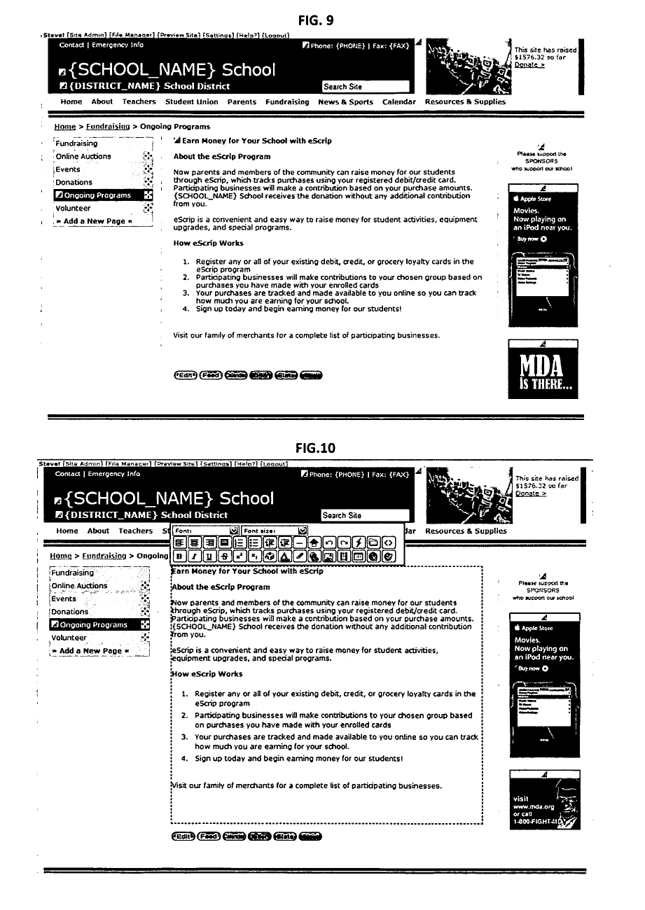

2. Client web page (12) has certain editable content areas (16 & 17) highlighted or otherwise identified visually as being editable (FIG. 9).

3. Authorized user selects the editable region to modify.

4. A toolbar is generated (FIG. 10) by JavaScript code and DHTML, whereby the authorized user can edit the content of the editable area using WYSIWYG (what you see is what you get).

5. Upon submission of the modified content by clicking on a save button, modified content is transmitted to Web Server (9) via the Internet. This submission is performed in the background using a standard method call that is present in all modern browsers named XMLHttpRequest (http://www.w3.org/TR/XMLHttpRequest/). By submitting information in this fashion, no refresh or reload of the edited web page is necessary. This is also referred to in the Industry as AJAX (Asynchronous JavaScript and XML).

6. Web Server (9) and Server Program (5) receive the modified content and confirm that the client user/editor has correct permission to make modifications. Once confirmed, original content that is stored in Website Content Database (3) is archived and time stamped into a Revision Database. Modified content is then stored in Website Content Database (3) replacing original content.

### Adding New Web Pages

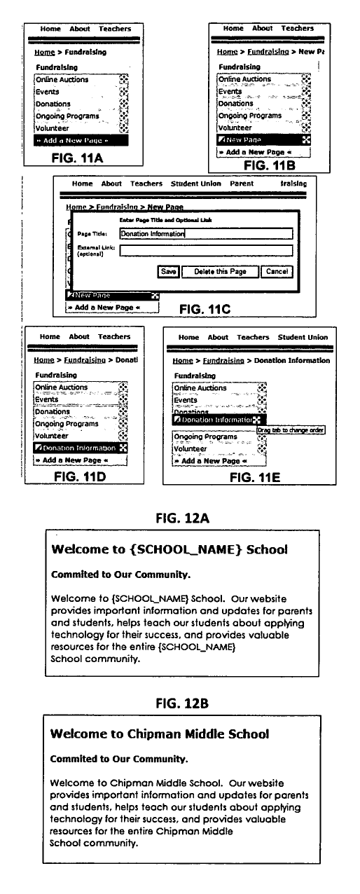

When an authorized user is logged into the website, an additional link is added to the sub-navigation with the title “Add a New Page” (FIG. 11A). When the user clicks this link, a new page is added to the website with a page title of “New Page”, and the new page is displayed to the user (FIG. 11B).

### Renaming and Reordering Web Pages

The authorized user may change the title of a page by clicking on the visual edit icon of the page title (FIG. 11C and FIG. 11D), and may re-order the pages in the navigation by dragging them into a new position with the mouse (FIG. 11E). Navigation indent levels may also be changed by dragging a navigation link with the mouse allowing the ability to create a nested hierarchy to the navigation of the website.

### Part III

### Content Substitution

Each page that has content containing specific school information such as school address, phone number, contact information, etc, has areas within the pre-written content that are specially marked-up so that specific school information from the school information database will be substituted for these markups These tags could be in any form as long as they are differentiable from other content or tags that might be found in the content of a web page. In the preferred method, a unique name surrounded by { } curly brackets is used. Illustrated in FIG. 12A and FIG. 12B, {SCHOOL_NAME} tag is replaced by “Chipman Middle” in several places within the content of the web page. “Chipman Middle” is the school name found in the master school database on a server.

### Some Markup Tags Currently in Use are Listed Below:

| | |
|---|---|
| {SCHOOL_NAME} | School name |
| {CDS_CODE} | Unique school number |
| {PHYS_ADDRESS} | School physical location street address |
| {PHYS_ZIP} | School physical location ZIP code |
| {PHYS_STATE} | School physical location state |
| {LATITUDE} | School location latitude |
| {LONGITUDE} | School location longitude |
| {MAIL_ADDRESS} | School mailing address |
| {MAIL_ZIP} | School mailing address ZIP code |
| {MAIL_STATE} | School mailing address state |
| {PHONE} | School phone number |
| {FAX} | School fax number |
| {DISTRICT_NAME} | School district name |
| {DISTRICT_LINK} | Name and website link of school district |
| {COUNTY_NAME} | School county name |
| {ZIP5} | 5 digit zip code |
| {ENROLLMENT_TOTAL} | School enrollment count |
| {GRADE_LOW} | Low grade in school (ie K for |
| | kindergarten) |
| {GRADE_HIGH} | High grade in school (ie 12 for 12^{th} |
| | grade) |
| {CONTACT_NAME} | School contact person |
| {CONTACT_SALUTATION} | School contact person salutation |
| {CONTACT_TITLE} | School contact person title |
| {CONTACT_PHONE} | School contact person phone |
| {CONTACT_EMAIL} | School contact person email |
| {WEATHER} | Local weather report based on school |
| | location |
| {MAP} | Street map to the school |
| {UPCOMING} | List of upcoming events from school |
| | calendar |
| {CALENDAR} | School calendar |

Other special tags are used that can be inserted by the system administrator such as {LOCKED} which locks a content area so as to disallow a school to be able to make changes to the content, and {BROADCAST_NNNNNN} which pulls content from a specified content record in a database and can be used to populate multiple websites with the same content.

### Exemplary Website Structure

Web pages and sections for a typical K-12 school are outlined below, also showing the navigational hierarchy. Screenshots of typical school web pages are illustrated in FIG. 13A and FIG. 13B.

### 1. Home Page

### 2. About Page

2.1 Vision

2.2 History

2.3 Map & Location

2.4 Faculty

2.5 Curriculum

2.6 Admissions

2.7 Special Services

2.8 Special Programs

2.9 Contact Information

2.10 School District Information

2.11 Accountability & API Scores
2.11.1 STAR Results
2.11.2 API Results
2.11.3 AYP Results

2.12 Policies
2.12.1 Attendance
2.12.2 Sexual Harassment
2.12.3 Visitors
2.12.4 Field Trips
2.12.5 Complaints

2.13 Procedures
2.13.1 Communication
2.13.2 Emergency Forms
2.13.3 Illness/Accident
2.13.4 Immunization
2.13.5 Student Medication
2.13.6 Health Services
2.13.7 Exclusion from School
2.13.8 Meals
2.13.9 Homework
2.13.10 Conferences
2.13.11 Weather Days

2.14 Emergency Information
2.14.1 Earthquake/Fire/Natural Disasters
2.14.2 School Emergencies
2.14.3 Alerts

### 3. Teachers

3.1 Teacher Forums

3.2 Teacher/Class Section 1

3.3 Teacher/Class Section 2

3.n Teacher/Class Section N

### 4. Students

4.1 Student Forums

4.2 Student Handbook

4.3 School Newspaper

4.4 Student Council

4.5 Student Services

4.6 Games

### 5. Parents

5.1 Parent Forums

5.2 Parenting Support

5.3 Parent Teacher Association (PTA)

5.4 Forms & Applications

5.5 Tutoring Resources

### 6. Fundraising

6.1 Online Auctions

6.2 Events

6.3 Donations

6.4 Ongoing Programs

6.5 Volunteer

### 7. News

### 8. Athletics/Sports

8.1 Athletic Department 1

8.2 Athletic Department 2

8.n Athletic Department N

### 9. Calendar

### 10. Resources and Supplies

10.1 School Supplies

10.2 Bookstore

10.3 School Store

10.4 Library

### School Web Page Content and Applications

Most web pages listed above are pre-populated with editorial content that is written in a generic enough fashion to apply most schools. There are different versions of content for various regions and nationalities. The generic content is interspersed with special replacement tags as described in Part III above and illustrated in FIG. 12A and FIG. 12B that are replaced with school specific information retrieved from the database during the web page generation process. The generic content consists of text, graphics, links and other media that are relevant to each page or section of the website.

In addition to generic content, some web pages also contain specialized functions, programs or features described specifically below and referencing the exemplary website structure listed above:

### Home Page (Site Structure 1.0)

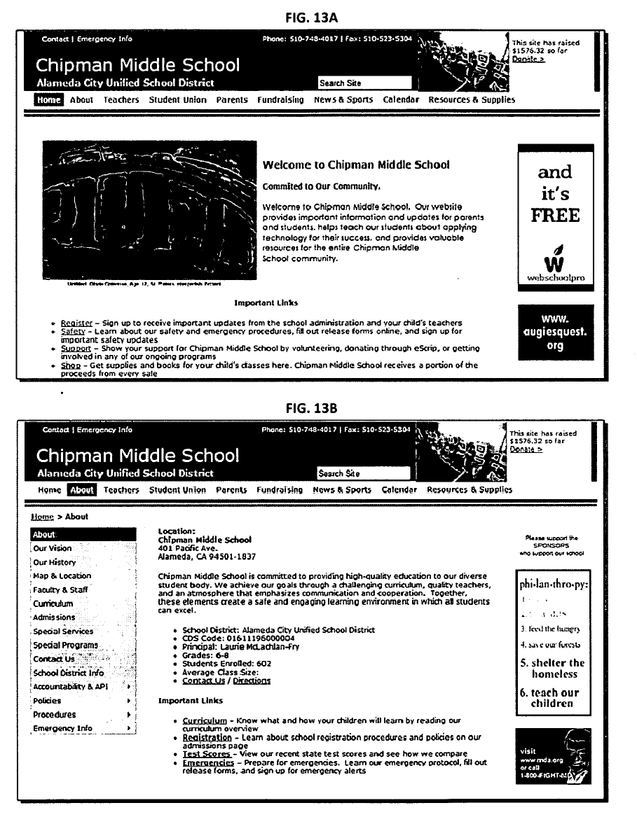

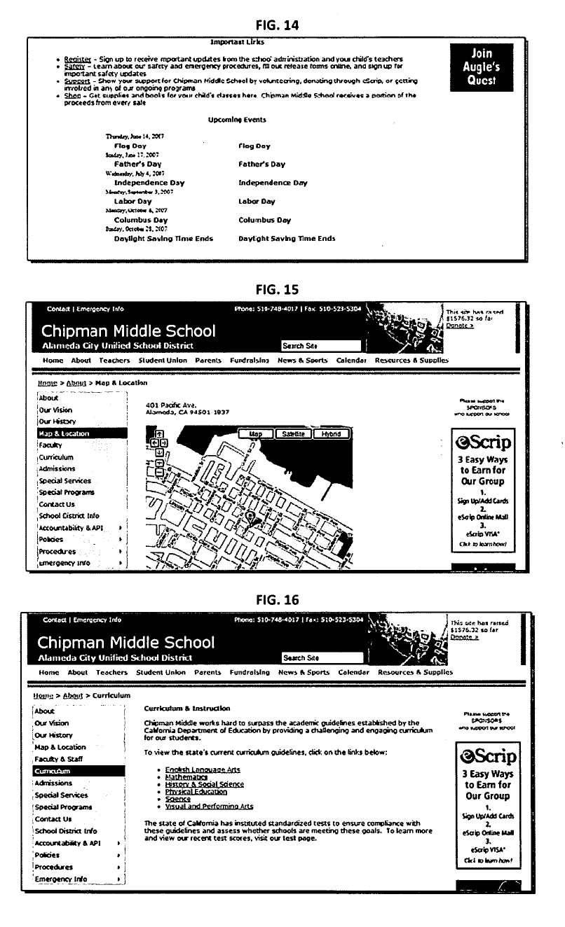

In addition to other standard content the home page contains a list of upcoming events (FIG. 14). These events are dynamically generated from the school calendar which is found on the Calendar page (Site Structure 9.0)

### Map & Location Page (Site Structure 2.3)

School physical address and in some cases map coordinates given in latitude and longitude are gathered from publicly available sources and stored in a database. A map of the location of a school is automatically generated and placed on this web page by using an external service such as Google Maps, Map Quest or other available online services (FIG. 15).

### Curriculum Page (Site Structure 2.5)

Each State Department of Education has a website with a variety of resources, regulations, procedures and other guidelines that is publicly available via the Internet and in electronic and printed documents. As each school website is created, links to these various resources are automatically inserted into appropriate sections and pages of the website (FIG. 16).

### STAR and AYP Standarized Testing Results Page (Site Structure 2.11.1)

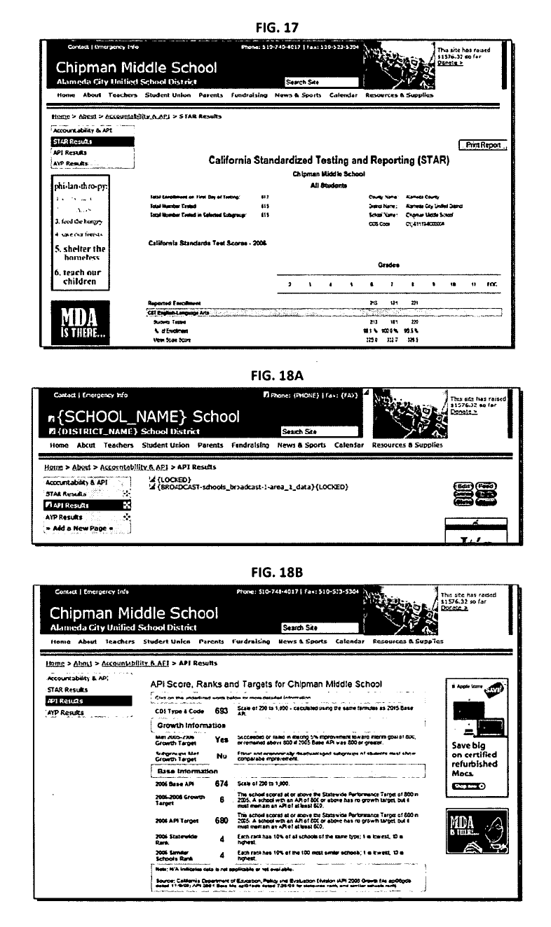

Certain content such as STAR and AYP testing results from the State of California and similar results from other states are retrieved as a full web page from an external website and inserted into a web page with the use of IFRAMES, an HTML tag that creates a browser window inside of another web page (FIG. 17).

### API Testing Results Page (Site Structure 2.11.2)

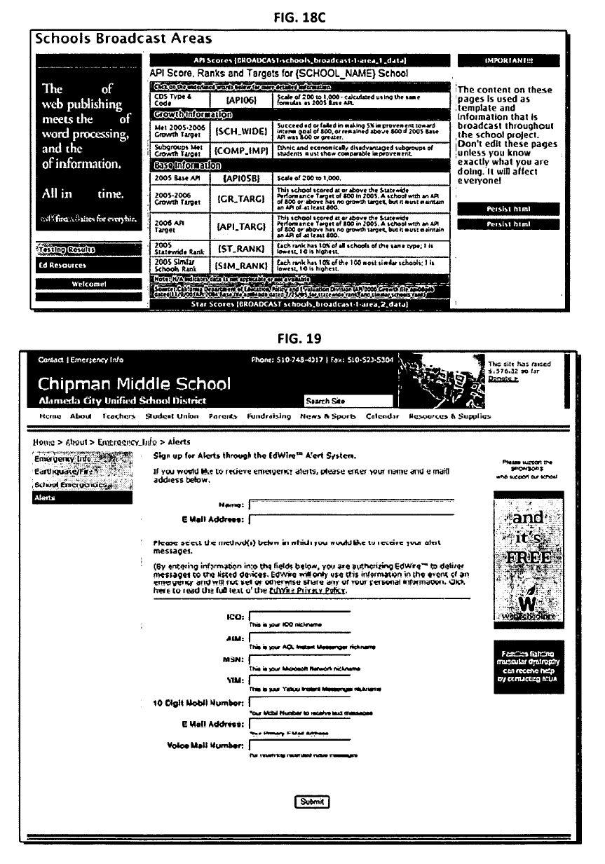

Certain data such as the California API scores are stored in a server database local to the website, but rather than insert the data directly into a web page on the school website, content is populated from the database content area of a shared website that we refer to as a “broadcast site”. In this way, as the information changes from year to year, and the format of the table changes with it, only the content of the broadcast site need to be changed and all schools that use the same information are updated automatically. In this particular case a markup tag is placed into the content area of the web page (FIG. 18A). Note that the illustration shows the page in edit mode so as to be able to see the markup tags.

This markup instructs the server to retrieve the information from a special website residing on the same server with an internal name “school_broadcast”, and to retrieve the information from page 1, area 1 of that website (FIG. 18B and FIG. 18C).

### Broadcast Website

The common website that is used to broadcast content is updated once and all school websites that use that information are updated simultaneously. (FIG. 18C) illustrates a broadcast page. Notice that the API table is not populated with actual school data, but only replacement markup tags so that once this information is present in a certain school website, the data inserted from the database is specific to that school. Notice also that the colors of the information need not be the same as in the broadcast site because of the use of CSS for website styling.

### Policies Pages (Site Structure 2.12 Thru 2.12.5) and

Procedures Pages (Site Structure 2.13 thru 2.13.11)

These sections and one or more pages in these sections consist of standardized content derived from various Federal and State Education Departments, as well as a compilation of various information from other sources. This section demonstrates how organizations like K-12 schools throughout the U.S. conform to similar standards thus making it possible to automate the creation of pre-populated websites.

### Emergency Information Pages (Site Structure 2.14 Thru 2.14.3)

General emergency information such as that for fire, chemical hazard, or human created incidents is the same for all schools. Location specific emergency procedures for example Earthquake preparedness and evacuation procedures are populated in this section based on information collected in advance for different regions of the U.S.

### Emergency Alerts Page (Site Structure 2.14.3)

Parents, students and teachers can sign up on this page to receive alerts in the event of school or community emergencies (FIG. 19). Alerts are offered via text message (SMS) messages to cell phones, email, and other messaging services like AIM. Other communication methods may be used such as telephone voice messages.

In the event of a school or community emergency, school administrator, district administrator or other person with authorization, can log into a server web page alert administration panel and enter a text and/or voice message to be delivered to subscribers of this service.

### Teachers Section and Pages (Site Structure 3.)

The teacher section of a school website is unique in that individual teacher sections may be added for each teacher or class in a school. The website administrator or other authorized person may assign permission to edit each of these teacher sections and pages to different users. Teachers in turn may assign permission to individuals such as students to edit or create new content in sub-pages of a teacher section.

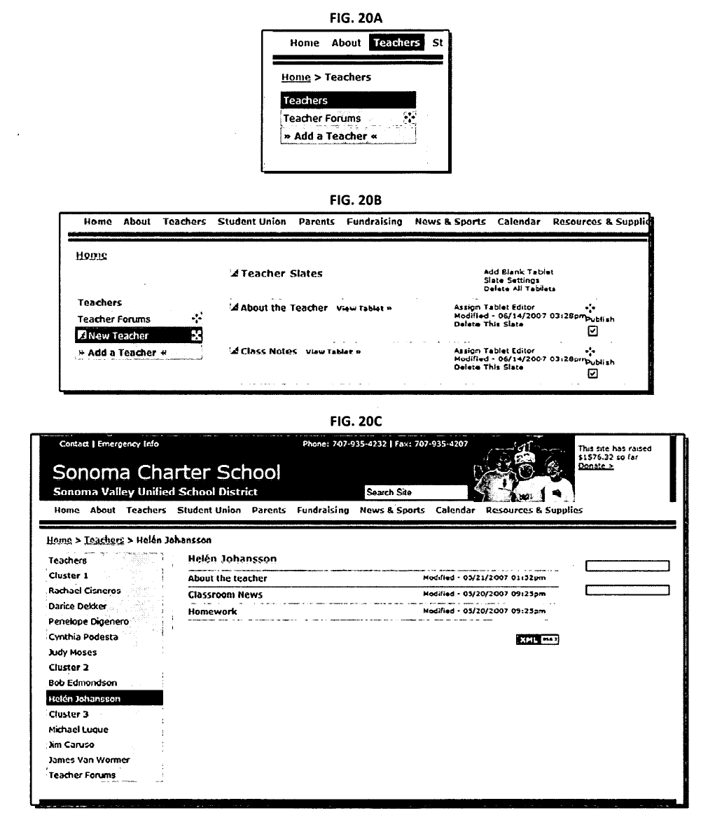

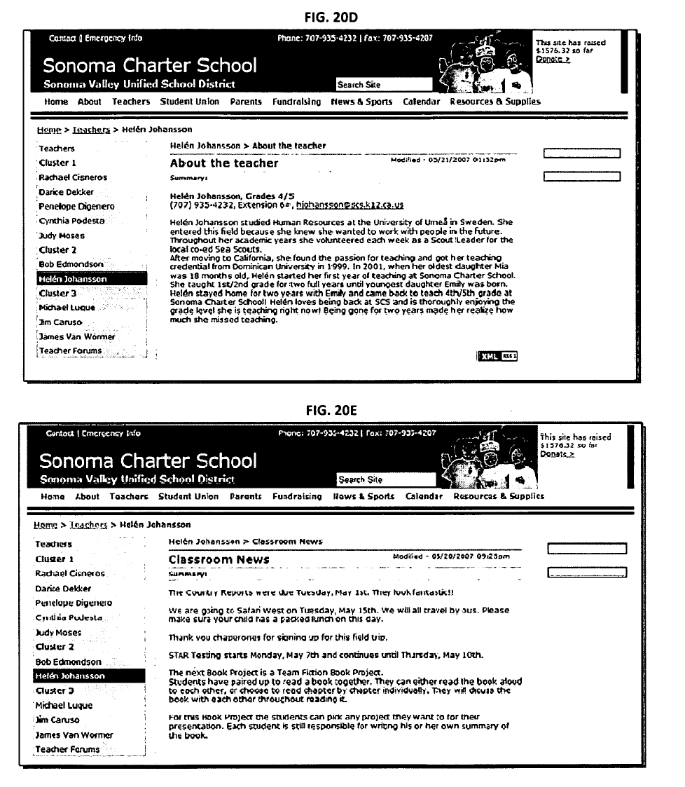

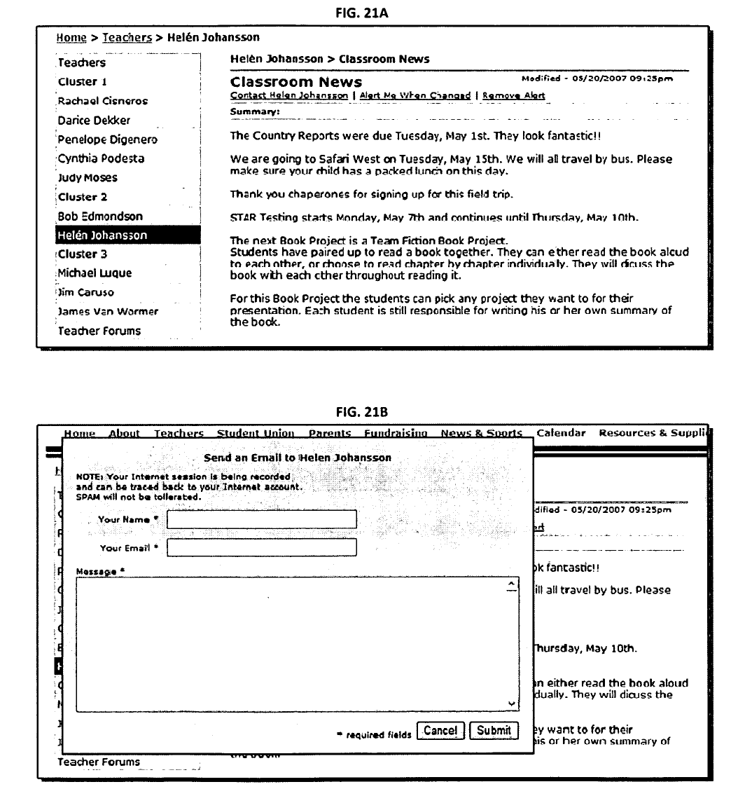

When a website administrator logs in, a new link appears in the sub-navigation—“Add a Teacher” (FIG. 20A). When “Add a Teacher” is clicked, a new teacher section is created, with one or more predefined sub-pages (Slates) created automatically (FIG. 20B). At the same time, another “Add a Teacher” link appears. (see section on Slates for more details).

The administrator assigns the teacher a username and password in the website administration panel. The teacher has the ability to then add as many sub-pages, “Tablets”, to their personal page/section as necessary by clicking on the “Add Blank Tablet” link (FIG. 20B).

In FIG. 20C, the teacher Helen has added 3 Slate Tablets to her section. Links to each Tablet are created automatically. FIG. 20D and FIG. 20E show the resultant page when one clicks on these links.

### Teacher Section and Slate Features (Site Structure 3.)

Teachers and administrators have the ability to change various settings for individual teacher pages, and to enable certain special features for each teacher page (Slate) and sub-page (Slate Tablet).

### Contact Form Feature

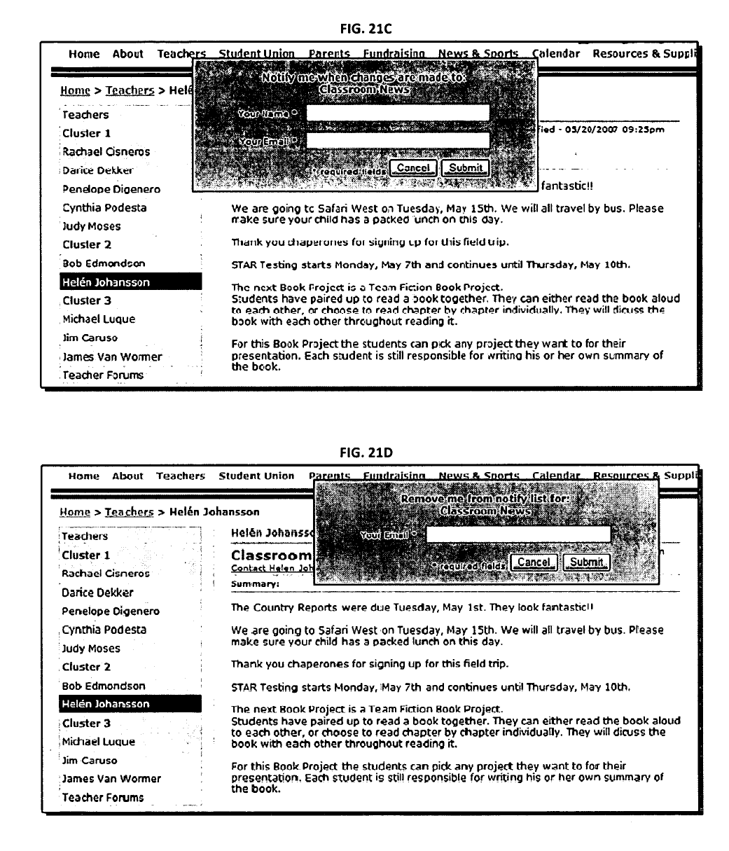

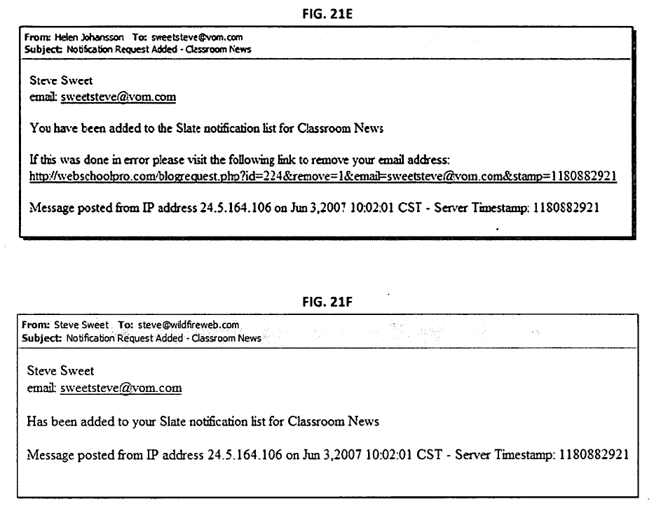

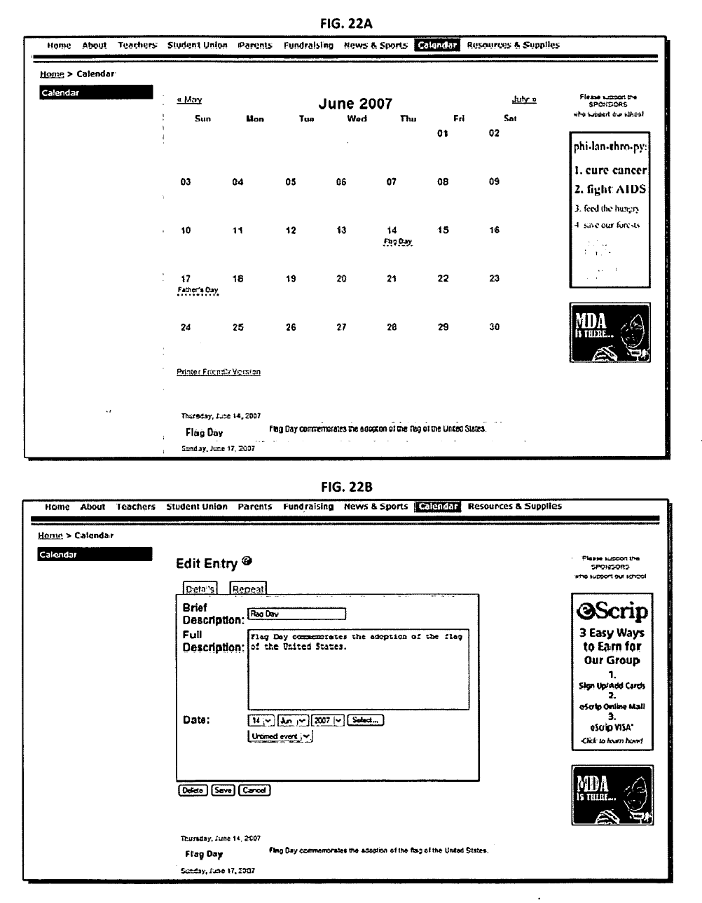

By enabling the Contact Form feature of a page, a link or button to contact the page owner/author is automatically inserted into the content of the page (FIG. 21A). When a visitor clicks on the link, an email contact form appears (FIG. 21B) which when submitted sends an email to a specified email address recorded earlier in a database.

### Page Content Change Alert Feature

By enabling the Alert Notification feature of any teacher page, website visitors are given an option of subscribing to be alerted whenever changes are made to the content of the web page (Slate). When the website visitor clicks on “Alert Me When Changed” link or button (FIG. 21A), a signup form appears (FIG. 21C), allowing the visitor to input their name, email address, and other information.

A subscribed visitor may remove themselves from an alert subscription by clicking the “Remove Alert” link (FIG. 21D).

### Authentication of Person Subscribing or Un-Subscribing From an Alert or Email List

When a visitor subscribes or un-subscribes to an email alert, an email address is a required field in the signup form (FIG. 21C and FIG. 21D). Before adding the new subscription, or removing a previous subscription, an email is sent to the subscriber's specified email address allowing the subscriber to opportunity to verify the subscription or un-subscription (FIG. 21E).

Each email confirmation as well as database record of a subscription or un-subscription contains information such as IP address and timestamp so as to allow tracing of the origination client computer and network in the event of spam or other unsolicited or unwanted or illegal activities.

Once a visitor has successfully subscribed or un-subscribed to an email alert an email is sent to the website page owner/author confirming the action (FIG. 21F).

### Teacher Forums (Site Structure 3.1)

The Teacher Forums page is one of several web based forums available in a school website. Other forums in a school website include but are not limited to Parent Forums and Student Forums. These are web pages where teachers, students or parents may log in with their unique username and password and join with peers in sharing ideas and resources with each other. Forum permissions are organized such that school administrators give teachers permission to join a forum, teachers give parents and students permission to join their respective forums and parents, teachers and administrators have access to student forums to help in monitoring and moderation of the student forums. By organizing the permissions in this way, forums become self-moderating and closed to outside influences from predators, spammers and other unwanted visitors.

### Calendars (Site Structure 9.)

Each school website has a calendar and events application installed on the Calendar page of the website (FIG. 22A). Additional calendars may be added by an authorized user on any other web page in the website. Each school's calendar may be pre-populated with a list of recurring events such as legal holidays. Each school calendar data is separate from other school calendars allowing each school to add or remove specific events from their calendar without affecting other schools or calendars on other pages within a school website.

Authorized users have the ability to add or edit calendar events (FIG. 22B) for their school. Events can be repetitive or single events, and can span a range of time. Each event can have a description.

### Shopping Cart

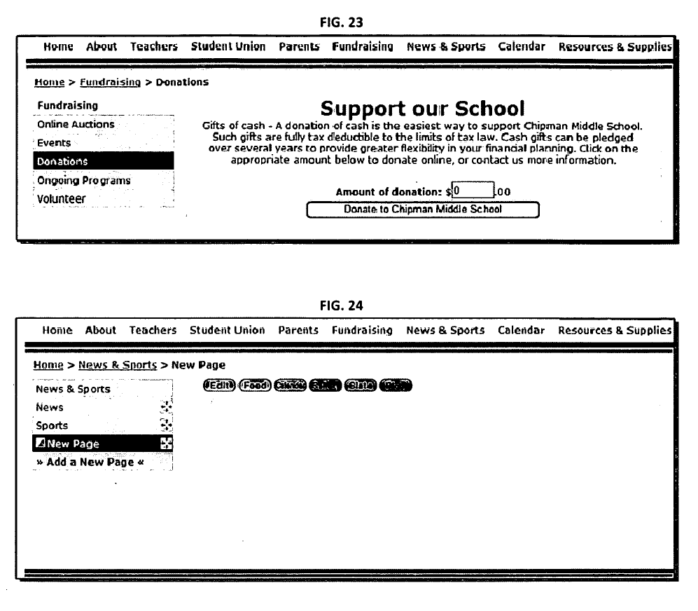

A shopping cart system (FIG. 23) is integrated into each website such that as a visitor adds items for purchase to the shopping cart and navigates between pages of the website, items and quantities remain persistent in the cart until the visitor checks out. When the visitor checks out they are taken to a secure (SSL) web page where they input personal and financial information. The server optionally communicates with a selection of credit card authorization services to receive payment authorization.

### Galleries, Blogs, Slates and News Feeds

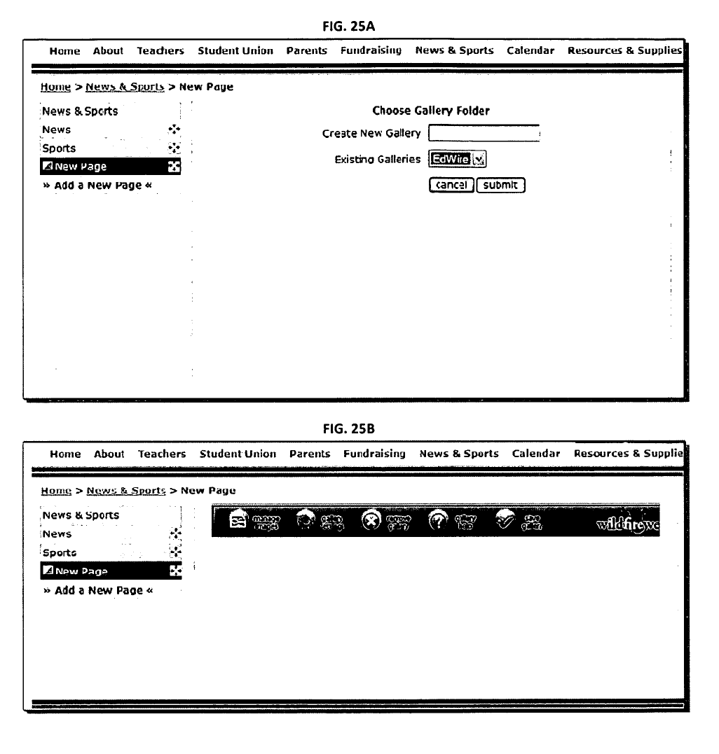

Photo Galleries, Blogs, Slates and News Feeds may be placed in any new or existing page of a school website. When an empty area of a web page is first presented in editing mode, a group of icons representing possible applications or functions to use in that area is shown (FIG. 24A).

### Galleries

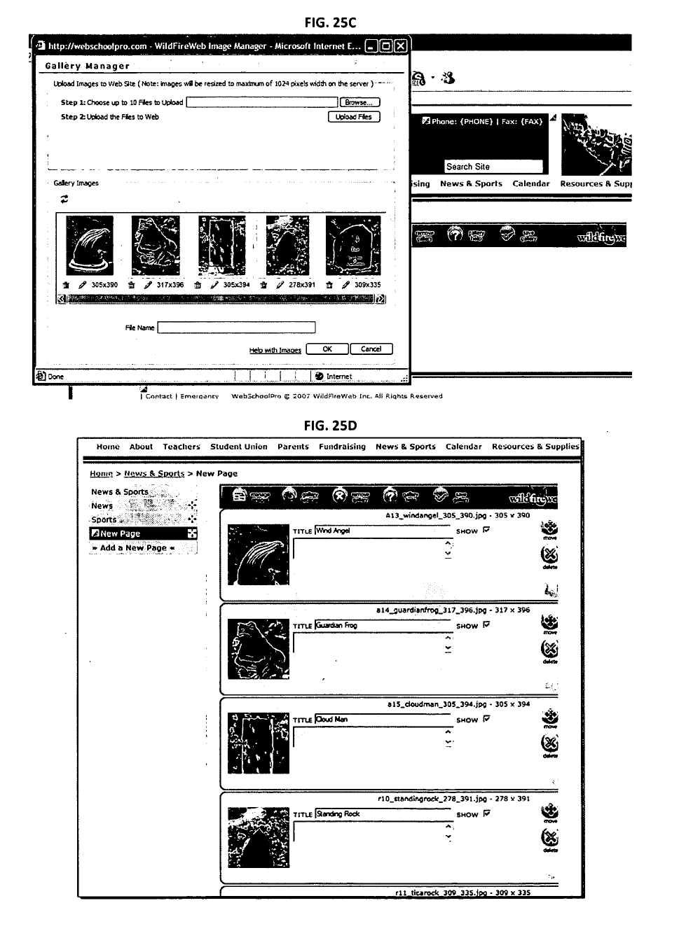

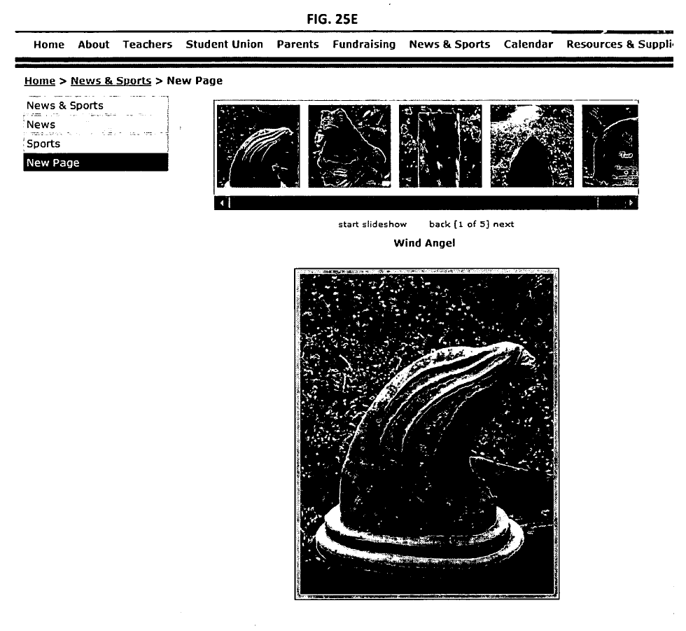

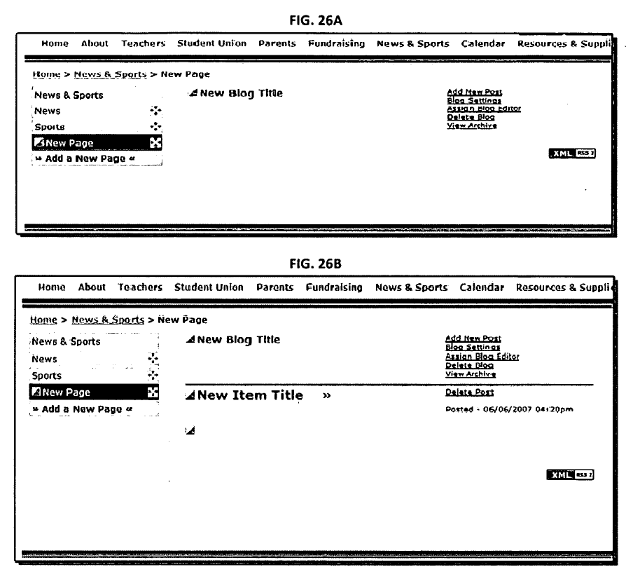

When the user clicks on the “Gallery” icon (FIG. 24), a form appears allowing the user to use an existing gallery or create a new gallery (FIG. 25A).

After creating a new gallery or selecting an existing gallery, the gallery management screen is displayed (FIG. 25B). In this example, a new gallery has been created. From the gallery management screen (FIG. 25C), the user may upload images to the gallery, delete images from the gallery, crop and resize images, and change a variety of settings that affect how the gallery is displayed to a site visitor.

When the user is finished uploading images to the gallery, they may reorder images by dragging images up and down, entering image titles and descriptions, and set various gallery settings such as slide show timing and gallery display options (FIG. 25D). All changes are made using AJAX (Asynchronous JavaScript and XML) so that web page reloads are not necessary. Once changes are saved and the user enters preview mode or logs out the gallery is displayed in the web page. (FIG. 25E).

### Blogs

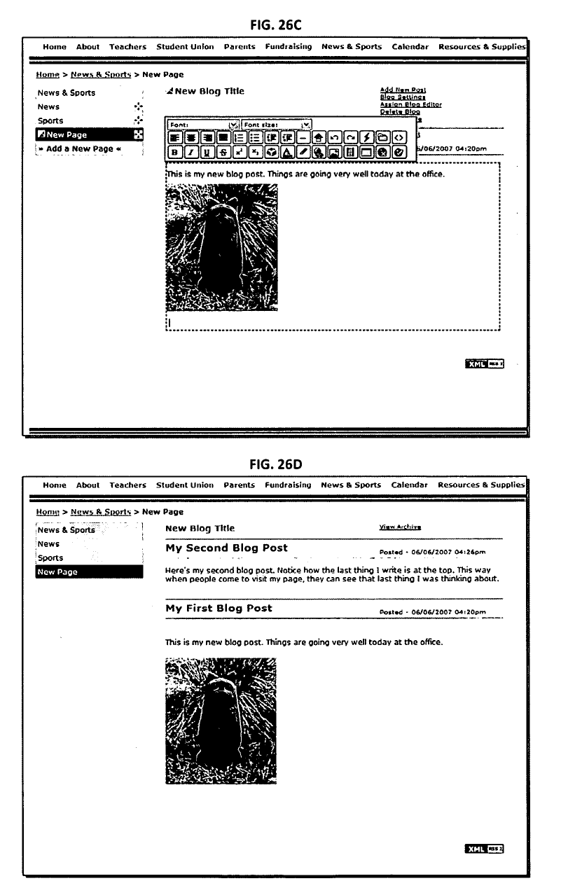

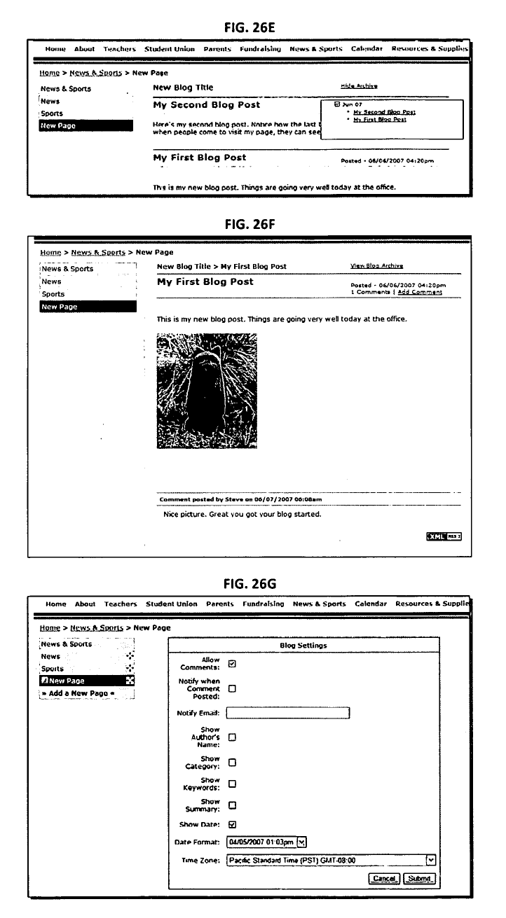

When the user clicks on the “Blog” icon (FIG. 24), a Blog (web log) is created in the content area of the web page (FIG. 26A). The blog allows the user to change the blog title, add new posts to the blog (FIG. 26B), assign an authorized editor to the blog, and set various display options and other features through a settings form (FIG. 26G).

FIG. 26C shows a blog post being edited in a similar fashion to that described in detail in the section “Editing the Content of a Website” above.

FIG. 26D shows several blog posts as they appear to a website visitor.

FIG. 26E shows an archiving feature of blogs which displays a limited number of blog posts on a web page but makes accessible all prior blog posts through the archives.

FIG. 26F shows blog comments that can be made by website visitors when the comments feature is enabled in the blog setting form (FIG. 26G).

### Slates

### Slates Overview

Slates represent a method of adding and organizing a virtually unlimited amount of content onto a single web page. Slates can be used to dynamically expand the size and navigation of an existing website. Slates can contain virtually all of the same content that any web page can, including text, images, links, galleries, media files and more.

Unlike individual web pages that limit content to the physical size of the current page, one can add as many Slate “Tablets” to a page as one likes. In essence, Slates present a means of adding many automatically linked “sub pages” (Slate Tablets) to a single web page.

Although Slates resemble Blogs in some ways, the differences are manifold:
1) Each Slate Tablet can be assigned a different authorized editor.
2) Slate Tablets can be ordered in any fashion and not only ordered by posting date as Blogs are.
3) Each Slate Tablet contains a built in contact form which can be enabled or disabled and that allows website visitors to contact the slate editor by email.
4) Each Slate Tablet has a feature, which can be enabled or disabled, that allows notifications to be sent to a list of subscribed people when the content of the Slate Tablet is modified.
5) Slate Tablets contain a summary or abstract field, keywords field and category field which can be enabled or disabled and that allow for search functionality not present in Blogs.
6) Each Slate Tablet can have a different author.

In a school website Slates are ideal for a number of purposes. School administrators can create an index of all their faculty and departments. Teachers can easily create lesson-plans or special messages for their students. Teachers can assign student editors to Slate Tablets. Slate Tablets come with the option for email notification when the Slate Tablet is updated or changed. This is all handled transparently so the teacher only has to work on their content and not administrative duties. Students and parents can sign up for email notification when Slate Tablet content has been modified.

Using Slates school administrators have for example the ability to easily post daily messages, schedules of events, news, or athletic team results. All this can be accomplished within minutes instead of the lengthy turnaround time of traditional website updating.

Much like the educational market, businesses will find slates a fast and easy way to keep their customers and their employees up to date on the latest company policies, events, news, and products. Slates make displaying product descriptions fast and easy. Customers can choose from a list of products on one page. By clicking the link the Slate Tablet will open to display an individual product or message.

### Adding a Slate to a Web Page

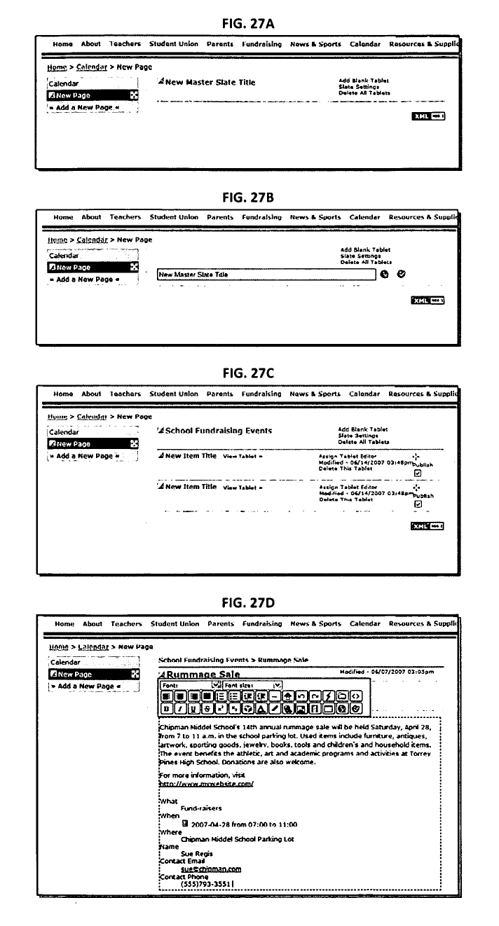

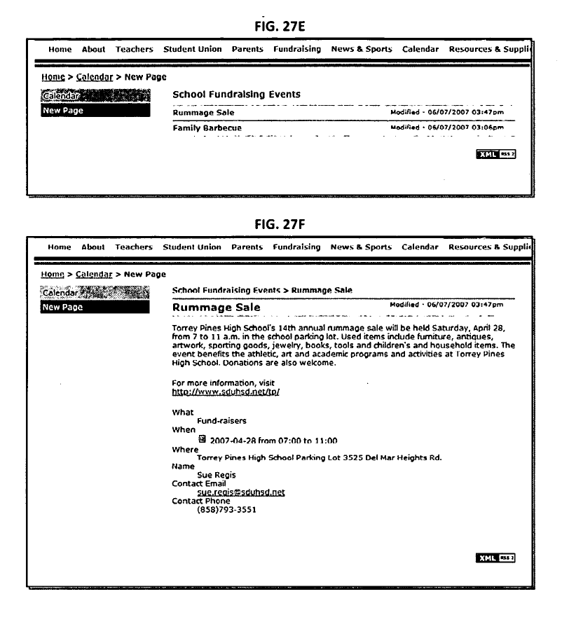

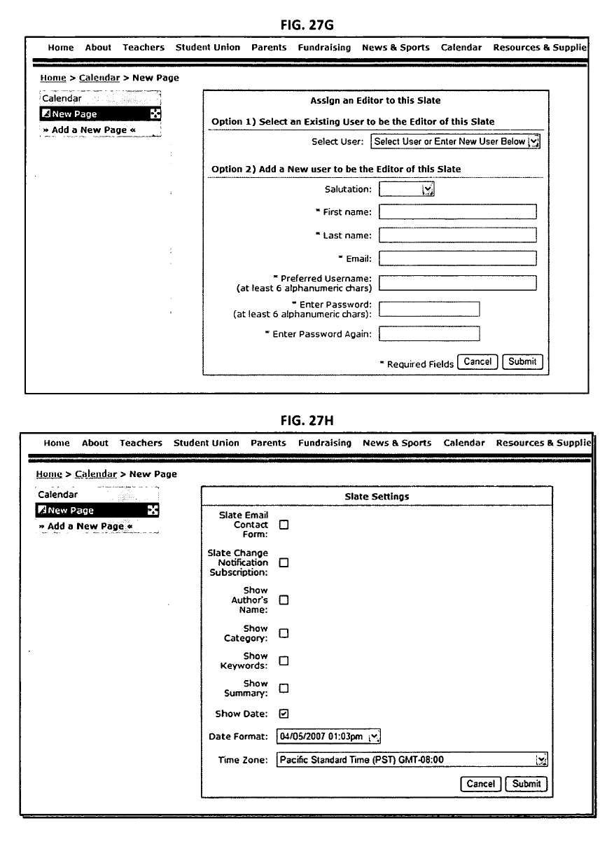

When the user clicks on the “Slate” icon (FIG. 24), a new Slate is created in the web page (FIG. 27A). The user can edit the title of the Slate (FIG. 27B), edit Slate settings (FIG. 27H), add blank Slates Tablets (FIG. 27C) and assign users to Slate Tablets (FIG. 27G).

### Adding Slate Tablets to a Slate

Each time the user clicks on “Add Blank Tablet” a new Slate Tablet is inserted into the page. FIG. 27C illustrates two new Slate Tablets having been added to a Slate. Slate Tablets may be renamed as illustrated in FIG. 27E. Slate Tablets may be reordered by dragging them up or down with a mouse or keyboard.

### Adding and Editing Slate Tablet Content

An authorized user clicks on the edit icon to enter new content or edit existing content of a Slate Tablet. The content area of the Slate Tablet opens into a WYSIWYG editable area with a toolbar (FIG. 27D). Text, images, links, movies and other types of media may be inserted into each Slate Tablet area. The process of editing is described in detail in the section “Editing the Content of a Website” above. Slate Tablets also allow galleries and calendars to be inserted in the same manner as described above for web pages.

### Navigating Slates and Tablets in Viewing Mode

When a website visitor views a web page that contains a Slate, a list of Slate Tablets and links to each Slate Tablet is automatically generated (FIG. 27E). If the visitor clicks on one of the Slate Tablet links, they are taken to the Slate Tablet content (FIG. 27F) which remains in the context of the same web page. Navigation back to the main Slate page is performed through a “bread crumb trail” links (FIG. 27F) “School Fundraising Events>Rummage Sale”.

### Assigning and Editor to a Slate Tablet

An authorized user may add authorized editors to each Slate Tablet by clicking on the “Assign Slate Editor” link (FIG. 27C). A control panel appears that allows the user to add a new editor or select from a list of existing users (FIG. 27G).

### Slate File Storage

Each individual Slate Tablet is given separate private file system space on the server so that individual Slate Tablet editors/owners can upload and link to files, images and other media and those files are kept separate and secure from other Slate and website users.

### Syndicated News Feeds (RSS)

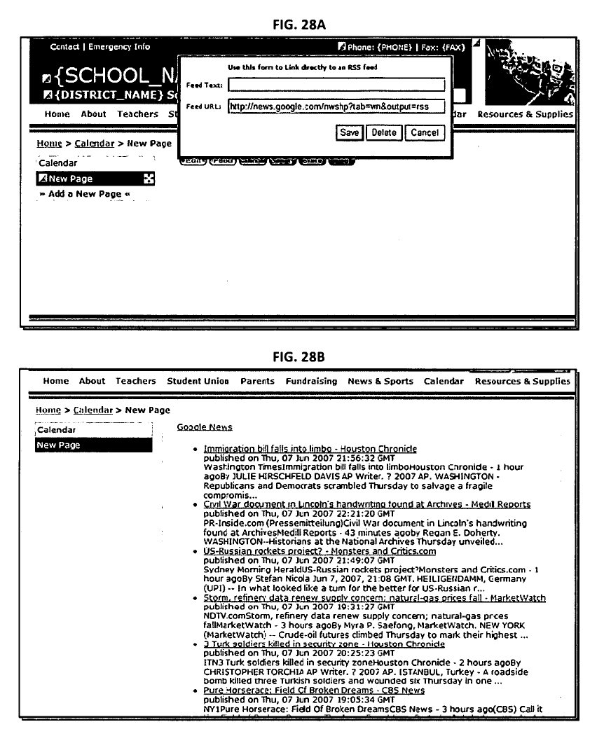

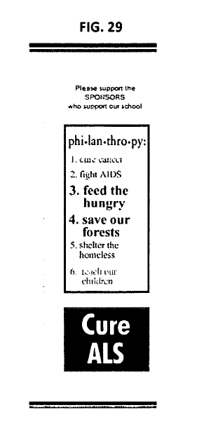

When the user clicks on the “Feed” icon (FIG. 24) in any blank content area in a web page or Slate Tablet, a dialog window appears (FIG. 28A) into which the user enters a valid RSS link. An example RSS link from Google News is http://news.google.com/nwshp?tab=wn&output=rss. Once the user submits the link, a news feed is automatically generated in the content area of the page (FIG. 28B). News feeds are automatically updated each time a web page is refreshed so that news is always up-to-date.

### Advertising

Each web page in a school website has several areas reserved for revenue generating advertising (FIG. 29, FIG. 13A). Each of these areas contains a unique identifier that identifies the school website, the section of the website, the page of the website and the area of the page.

Code is contained in each area to request an advertisement from an advertising server and to transmit the unique identifier to the advertising server.

Additional information such as website visitor information, if available, is also transmitted to the advertising server. This visitor information will be available in various sections of the website that require an authenticated user to be logged in, as well as certain sections of the website that are targeted toward specific audiences such as students, teachers or parents.

Because demographic information is stored in the server database for each school such as location, attendance, grade levels, number of teachers, etc, then an advertising server can place advertisements in each area of each page that is targeted towards a specific demographic such as region, community, city, local business and specific website visitor type depending upon the area of the website being viewed and whether the visitor is logged into the website to use one of its many applications.

### Database Structure

The following tables represent the database structures used to store information about schools, users, activation and authentication, websites, web pages and content revisions. This is typical information and may vary from region to region as more or less information is available.

TABLE 1
SCHOOLS DATABASE

| FIELD | TYPE | DESCRIPTION |
|---|---|---|
| school_code | varchar(32) | unique school identifier |
| county_name | varchar(15) | county or region of school |
| district_name | varchar(50) | district name of school |
| school_name | varchar(50) | name of school |
| phys_address | varchar(60) | physical street address of school |
| phys_city | varchar(25) | physical city of school |
| phys_zip | varchar(10) | physical postal code of school |
| phys_state | char(2) | physical state of school |
| latitude | varchar(10) | latitude of location of school |
| longitude | varchar(10) | longitude of location of school |
| mail_address | varchar(60) | mailing street address of school |
| mail_city | varchar(25) | mailing city of school |
| mail_zip | varchar(10) | mailing postal code of school |
| mail_state | char(2) | mailing state of school |
| phone | varchar(50) | phone number of school |
| fax | varchar(50) | fax number of school |
| email | varchar(50) | email address for school |
| contact_salutation | varchar(50) | school contact person salutation |
| contact_name | varchar(50) | school contact person name |
| contact_title | varchar(50) | school contact person title |
| contact_phone | varchar(50) | school contact person phone number |
| contact_fax | varchar(50) | school contact person fax number |
| contact_email | varchar(50) | school contact person email address |
| accomodations | varchar(50) | indicates if school has overnight accomodations |
| grade_low | varchar(50) | lowest grade level in school |
| grade_high | varchar(50) | highest grade level in school |
| enrollment_total | varchar(50) | total students enrolled at the school |
| teachers_fulltime | varchar(50) | total full time teachers at the school |
| school_classification | varchar(50) | type of school, i.e. Public, Private, Religious |
| church_affiliation | varchar(50) | if a religious school, the church affiliation |
| district_website | varchar(50) | school district website address |
| district_phone | varchar(50) | school district phone number |
| district_fax | varchar(50) | school district fax number |
| district_mail_address | varchar(60) | school district mailing street address |
| district_mail_city | varchar(50) | school district mailing city address |
| district_mail_state | char(2) | school district mailing state address |
| district_mail_zip | varchar(10) | school district mailing postal code |

TABLE 2
USER DATABASE

| FIELD | TYPE | DESCRIPTION |
|---|---|---|
| school_id | int(11) | school id for which this user is an |
| | | authorized user |
| username | varchar(64) | user login identifier |
| userlevel | tinyint(1) | permission level |
| password | varchar(32) | encrypted user password |
| email | varchar(64) | user email address |
| first_name | varchar(32) | user first name |
| last_name | varchar(32) | user last name |
| editor_site_ids | text | list of sites ids this user is authorized to |
| | | edit |
| editor_page_ids | text | list of page ids this user is authorized to |
| | | edit |
| editor_area_ids | text | list of area ids this user is authorized to |
| | | edit |
| session_id | varchar(32) | persistent session identifier |
| created | int(11) | timestamp when the user account was |
| | | created |
| expires | int(11) | timestamp when the user account |
| | | expires |
| lastactive | int(11) | timestamp when the user last logged in |

TABLE 3
ACTIVATION AND AUTHENTICATION DATABASE

| FIELD | TYPE | DESCRIPTION |
|---|---|---|
| school_code | varchar(14) | school identification code |
| activation_code | varchar(32) | secret activation code |
| ip | varchar(32) | IP address of person activating the |
| | | website |
| email | varchar(64) | email address of person activating the |
| | | website |
| activated | smallint(1) | boolean flag indicating if the school |
| | | website has been created |
| key_code | varchar(64) | secret key code |
| timestamp | int(11) | time and date of website activation |

TABLE 4
WEBSITE DATABASE

| FIELD | TYPE | DESCRIPTION |
|---|---|---|
| site_id | int(11) | unique website identifier |
| school_code | varchar(14) | school identification code |
| num_pages | int(11) | number of pages in website |
| max_pages | int(11) | maximum number of pages allowed in website |
| site_domain | varchar(64) | domain name of website |
| font | varchar(64) | default font selected for website |
| template | varchar(128) | file path to website template for website |
| css | varchar(128) | file path to style sheet for website |
| colors | varchar(128) | color scheme for website |
| persistent_content_1 | mediumtext | first website page content which can appear on |
| | | multiple web pages |
| persist_1_id | int(11) | identifier in revision database for past revisions of |
| | | content in persistent_content_1 |
| persistent_content_2 | mediumtext | second website page content which can appear on |
| | | multiple web pages |
| persist_2_id | int(11) | identifier in revision database for past revisions of |
| | | content in persistent_content_2 |
| persistent_content_3 | mediumtext | third website page content which can appear on |
| | | multiple web pages |
| persist_3_id | int(11) | identifier in revision database for past revisions of |
| | | content in persistent_content_3 |
| persistent_content_N | mediumtext | Nth website page content which can appear on |
| | | multiple web pages |
| persist_N_id | int(11) | identifier in revision database for past revisions of |
| | | content in persistent_content_N |
| lastmodified | int(11) | timestamp indicating when website content was last |
| | | modified |
| timestamp | int(11) | timestamp indicating when website was created |

TABLE 5
WEB PAGE DATABASE

| FIELD | TYPE | DESCRIPTION |
|---|---|---|
| site_id | int(11) | website that this page belongs to |
| page_id | int(11) | unique web page identifier |
| page | int(11) | page number of web site |
| page_order | int(11) | order of page in hierarchical navigation |
| level | int(11) | hierarchical level of page in navigation |
| template | varchar(128) | file path to web page template if different than |
| | | website template |
| alias | varchar(32) | alternate URL file name for the web page i.e. |
| | | “contacts.html”, “teachers.html” |
| protected | tinyint(1) | Boolean value indicating if page is protected from |
| | | viewing by non-authorized users |
| active | tinyint(1) | Boolean value indicating if page is currently being |
| | | used |
| published | tinyint(1) | Boolean value indicating if page is currently |
| | | published to the Internet |
| tab_title | varchar(128) | link title for page in hierarchical navigation |
| page_title | text | title of page for search engine optimization |
| page_keywords | text | keywords for search engine optimization |
| page_description | text | description of page for search engine optimization |
| tab_is_link | tinyint(1) | Boolean value indicating if hierarchical link is to an |
| | | external website |
| page_is_locked | tinyint(1) | Boolean value indicating if page parameters can be |
| | | edited by an authorized user |
| area_1_data | mediumtext | first web page content area storage |
| area_1_type | enum(‘feed’, ‘html’, | value indicating the type of content in the first area |
| | ‘blog’, ‘calendar’, | on the page. |
| | ‘gallery’, ‘slate’, | |
| | ‘contact’, ‘store’ | |
| area_1_id | int(11) | identifier in revision database for past revisions of |
| | | the content in area_1_data |
| area_2_data | mediumtext | second web page content area storage |
| area_2_type | enum(‘feed’, ‘html’, | value indicating the type of content in the second |
| | ‘blog’, ‘calendar’, | area on the page. |
| | ‘gallery’, ‘slate’, | |
| | ‘contact’, ‘store’ | |
| area_2_id | int(11) | identifier in revision database for past revisions of |
| | | the content in area_2_data |
| area_3_data | mediumtext | third web page content area |
| area_3_type | enum(‘feed’, ‘html’, | value indicating the type of content in the third area |
| | ‘blog’, ‘calendar’, | on the page. |
| | ‘gallery’, ‘slate’, | |
| | ‘contact’, ‘store’ | |
| area_3_id | int(11) | identifier in revision database for past revisions of |
| | | the content in area_3_data |
| area_N_data | mediumtext | Nth web page content area |
| area_N_type | enum(‘feed’, ‘html’, | value indicating the type of content in the Nth area |
| | ‘blog’, ‘calendar’, | on the page. |
| | ‘gallery’, ‘slate’, | |
| | ‘contact’, ‘store’ | |
| area_N_id | int(11) | identifier in revision database for past revisions of |
| | | the content in area_N_data |
| timestamp | int(11) | timestamp indicating when the page was created |

TABLE 6
CONTENT REVISION DATABASE

| FIELD | TYPE | DESCRIPTION |
|---|---|---|
| id | int(11) | unique identifier |
| content_id | int(11) | identifier of content area this content is |
| | | associated with |
| content | mediumtext | revision content |
| modified_id | int(11) | user id of the person who saved this content |
| modified | int(11) | timestamp of when this content was saved |

What is claimed is:

1. A system for creating, maintaining, generating and accessing user updateable websites and web pages for organizations, comprising: at least one server computer and at least one client computer, including respectively, server and client processors for executing server and client input and output for communications between said server and client computers; and said server computer further including: a database for storing information related to said organizations; a user database for storing unique identification information related to authorized users, said authorized users each comprising one of: system administrators, organization administrators, organization employees, and organization members; a content database for storing web page content comprising pre-written content and/or content that is created by said authorized users; user management means for allowing an administrator to add and remove authorized users, define the web page content that said authorized users can create, manage and process; means for storing said authorized user identifier and password information for each of the authorized users, and for each said web page content to which the authorized users have access; means for generating and delivering web pages through the Internet to a user having a client computer that employs a web browser.

2. The system of claim 1, further comprising: means to enable said authorized users to add, remove or modify web page content including but not limited to text and/or graphics directly through a web browser with or without using website markup language; means of saving said web page content to said server computer.

3. The system of claim 2, further comprising means to store several revisions of said web page content such that said authorized users can change to one of said several revisions of said web page content.

4. The system of claim 1, further comprising: at least one website data template that defines the graphical layout, presentation, and editable content areas of said website; means to enable said authorized users to change overall website appearance by selecting from alternate said website data templates.

5. The system of claim 1, further comprising: a file storage system on said server computer; means to enable said authorized users to upload, store and manage files on said file storage system; means of adding hyperlinks on web pages to said files stored on said file storage system.

6. The system of claim 1, further comprising means of protecting one or more web pages from being viewed by anyone other than said authorized users.

7. The system of claim 1, further comprising means to enable said authorized users to add, remove, name and/or rename web pages.

8. The system of claim 1, further comprising means of interconnecting (linking) web pages in said website through hierarchical navigation and means to enable said authorized users to change the order of said hierarchical navigation.

9. The system of claim 1, further comprising means of placing one or more event calendars on said web pages; means to enable said authorized users to add, edit or remove events from said event calendars; means to populate said event calendars with periodic events such as public holidays.

10. The system of claim 1, further comprising means of placing image galleries on said web pages and means to enable said authorized users to manage images in said image galleries.

11. The system of claim 1, further comprising means of placing a blog (weblog) on said web pages and means to enable said authorized users to add or remove blog content including but not limited to text and/or graphics to said blog directly through a web browser with or without using website markup language.

12. The system of claim 1, further comprising means of placing syndicated news feeds on said web pages.

13. The system of claim 1, further comprising means of placing contact forms on said web pages.

14. The system of claim 1, further comprising means of adding one or more sections to said website, said sections comprising one of: staff sections, department sections and miscellaneous sections.

15. The system of claim 1, further comprising a top-level navigation to each main section of a website and comprising sub-navigation within each said main section to sub-sections or web pages within said main section.

16. The system of claim 1, further comprising special markup tags that can be placed within said web page content such that the markup tags are replaced with information stored in said database at the time the web page is generated by said server computer.

17. The system of claim 1, further comprising means such that a visitor to said website can subscribe to web page to be notified by email when the content of said web page has been modified or when an authorized user chooses to notify them.

18. The system of claim 1, further comprising said content database that is pre-populated with content consisting of: information for a specific organization, information that is common to organizations of a similar type, information that is written in one or more languages, and links to various resources on the internet.

19. The system of claim 1, applied specifically to school organizations and further comprising means for parents, students and teachers to sign up to receive alerts in the event of school or community emergencies.

20. The system of claim 1, further comprising means of authenticating a person authorized to create and manage an organization's website.

21. The system of claim 1, further comprising means to deliver advertising that is targeted by locale and user demographics.

22. A web-based computer software application referred to as “slates” comprising means of adding sub-pages to a single web page and means of automatically inserting hierarchical navigation to said sub-pages within said single web page.

23. The system of claim 1, further comprising means of placing a said “slates” on said web pages and means to enable said authorized users to add or remove blog content including but not limited to text and/or graphics to said blog directly through a web browser with or without using website markup language.
